(19) United States
(12) Patent Application Publication
(10) Pub. No.: US 2026/0369656 A1
(43) Pub. Date: Nov. 19, 2026

(54) ROLLER PRESSING APPARATUS FOR TAB PROCESSING

(71) Applicant: XINGTAI HAIYU LITHIUM BATTERY EQUIPMENT CO.,LTD., Xingtai (CN)

(72) Inventor: Jianjun Miao, Handan (CN)

(21) Appl. No.: 19/298,108

(22) Filed: Aug. 12, 2025

(30) Foreign Application Priority Data
May 19, 2025 (CN) 202510642066.9

(51) Int. Cl. H01M 10/04

(52) U.S. Cl. CPC H01M 10/0481

(57) ABSTRACT

The present invention discloses a roller pressing apparatus for tab processing, comprising a support frame, an air pump, and a high-pressure oil pump. The concave base contains a lower pressing roller and an upper pressing roller structure arranged from bottom to top, with the motor driving the lower pressing roller and a gear assembly linking both components. The roller pressing thickness can be conveniently adjusted by using the air pump or high-pressure oil pump to fill air or hydraulic oil into the gap between the hollow shaft rods of the upper pressing roller. A cleaning mechanism processes the hydraulic oil to enable recycling, while the eccentric rotation of the outer roller ring relative to the hollow shaft rod enhances roller pressing uniformity. The support mechanism buffers impact forces to improve stability, and the filtration and defoaming treatment of the hydraulic oil increases equipment durability.

### CROSS-REFERENCE TO RELATED APPLICATION

This application claims priority of Chinese Patent Application No. 202510642066.9, filed on May 19, 2025, the entire contents of which are incorporated herein by reference.

### TECHNICAL FIELD

The present invention relates to the technical field of tab processing, and particularly to a roller pressing apparatus for tab processing.

### BACKGROUND ART

In lithium-ion battery manufacturing processes, electrode sheet roller pressing is a core operation that determines battery performance and safety. As a key component connecting the internal and external circuits of battery cells, tabs not only carry the triple functions of current transmission, insulation sealing, and structural support, but their roller pressing quality directly affects the battery's internal resistance, cycle life, and safety reliability. Current pre-rolling equipment for tab processing roller pressing cannot achieve online coordinated adjustment of elongation rates between tabs and the main body area of electrode sheets, resulting in mismatched deformation between the two, which easily causes interfacial stress concentration and tab fracture. The roller structure has insufficient adaptability; traditional rollers have fixed bite angles and cannot adjust contact area in real time, resulting in the need to replace rollers of corresponding sizes whenever electrode sheet raw material dimensions are changed, which is time-consuming and labor-intensive, has low work efficiency, and causes waste of materials and resources.

Chinese Patent Publication No. CN110224108B discloses a roller pressing apparatus for electrode sheets used in lithium-ion battery processing, comprising a base, wherein an outer shell is fixedly mounted on top of the base, a feed hopper is connected to the top of the outer shell, a debris removal structure is fixedly mounted inside the outer shell, and roller pressing structures are fixedly mounted on top of the base on both sides of the outer shell, the roller pressing structures including discharge outlets. The above-mentioned patent document achieves effective separation of lithium-ion battery electrode sheets by inserting limiting rods into the interior of feed pipes, avoiding overlapping roller pressing of battery electrode sheets during the roller pressing process, ensuring uniform roller pressing force on all parts of lithium-ion battery electrode sheets, improving the compaction density inside lithium-ion battery electrode sheets, and adjusting roller pressing force by increasing the volume of air cushions to compress lithium-ion battery electrode sheets, enabling lithium-ion battery electrode sheets to receive appropriate roller pressing force and improving the roller pressing effect of lithium-ion battery electrode sheets.

Although the above-mentioned patent document can adjust roller pressing force during the tab roller pressing process, regardless of how the roller pressing force is adjusted, it is only achieved by adjusting air pressure. If direct roller pressing using rigid force occurs, this apparatus is no longer applicable.

### SUMMARY OF THE INVENTION

The main objective of the present invention is to provide a roller pressing apparatus for tab processing that performs individual rolling of tabs, enabling tab elongation to match the elongation of the coated area of electrode sheets. This apparatus replaces the roller pressing portion of existing pre-rolling equipment for tab roller pressing. It can effectively solve the problem that regardless of how roller pressing force is adjusted, it is only achieved by adjusting air pressure, and if direct roller pressing using rigid force occurs, the apparatus is no longer applicable.

To achieve the above objective, the technical solution adopted by the present invention is:

A roller pressing apparatus for tab processing, comprising a support frame, an air pump, and a high-pressure oil pump, wherein the air pump and high-pressure oil pump are both installed on the inner right side of the support frame;

Inclined platforms are fixedly mounted on both front and rear sides of the upper end of the support frame, a concave base is fixedly mounted in the upper central portion of the support frame, a gear assembly is provided in the central portion of the left end of the concave base, a lower pressing roller and an upper pressing roller structure are rotationally connected from bottom to top in the inner central portion of the concave base, an outlet pipe is installed in the upper portion of the left end of the vertical section of the concave base, electronic valve 1 is provided in the upper portion of the outlet pipe, a motor and a three-way pipe are sequentially provided from bottom to top at the right end of the vertical section of the concave base, the motor is used to drive the rotation of the lower pressing roller, the gear assembly is used for linking the lower pressing roller and the upper pressing roller structure, a cleaning mechanism is fixedly mounted in the inner central portion of the support frame, two input ends of the three-way pipe are respectively equipped with an electronic valve 2 and an electronic valve 3, and the electronic valve 2 and electronic valve 3 are respectively installed at the output ends of the air pump and high-pressure oil pump, the input end of the high-pressure oil pump is connected to the bottom of the cleaning mechanism through a pipeline.

Preferably, the upper pressing roller structure comprises a hollow shaft rod 1, the hollow shaft rod 1 is rotationally connected to the inner upper portion of the vertical section of the concave base, both left and right ends of the hollow shaft rod 1 are rotationally connected to the outlet pipe and three-way pipe respectively, multiple support mechanisms are fixedly connected to the outer surface of the hollow shaft rod 1, all the support mechanisms are located within the inner cavity of the outer roller ring, an outer roller ring is sleeved on the outer surface of the hollow shaft rod 1, limiting holes are formed at both left and right ends of the outer roller ring, a hollow shaft rod 2 is installed in the inner cavity of the hollow shaft rod 1, a pointed cone is fixed to the left end of the hollow shaft rod 2, a sealing ring is fixed to the right end of the hollow shaft rod 2, the sealing ring is used to seal the right side of the inner cavity of the hollow shaft rod 1, multiple outlet holes are formed on the right side of the outer surface of the hollow shaft rod 2 near the sealing ring.

Preferably, the diameter of the outer roller ring is greater than the diameter of the limiting holes, the diameter of the limiting holes is greater than the diameter of the hollow shaft rod 1, enabling the outer roller ring to rotate eccentrically relative to the hollow shaft rod 2.

Preferably, the support mechanism comprises multiple liquid storage shells, pistons are slidably disposed in the inner cavities of all the liquid storage shells, a connecting rod is fixedly mounted in the central portion of the end of the piston away from the hollow shaft rod 1, an arc-shaped steel plate is fixed to the end of the connecting rod away from the liquid storage shell, a drain pipe and an inlet pipe are fixed on the side of the inner cavity of the liquid storage shell close to the hollow shaft rod 1, the drain pipe is used to connect the liquid storage shell and the hollow shaft rod 2, the inlet pipe is used to connect the liquid storage shell and the hollow shaft rod 1, multiple springs 1 are jointly fixed between the end of the piston away from the hollow shaft rod 1 and the liquid storage shell.

Preferably, multiple support mechanisms in the same vertical plane are defined as one group, and adjacent groups of support mechanisms have different installation angles.

Preferably, the cleaning mechanism comprises a conical cover, an arc-shaped bottom shell is threadedly installed at the bottom of the conical cover, the arc-shaped bottom shell is installed in the inner central portion of the support frame, the end of the pipeline away from the high-pressure oil pump is fixedly connected to and communicates with the bottom of the arc-shaped bottom shell, a metal filter screen is threadedly installed on the inner upper end of the arc-shaped bottom shell, a metal elastic vibration plate is fixed to the bottom wall of the inner cavity of the metal filter screen, multiple springs 2 are fixed in an annular array on the outer side of the lower end of the metal elastic vibration plate, magnet columns are fixed to the bottom of all the springs 2, multiple V-shaped blocks are fixed in an annular array on the inner side of the lower end of the metal elastic vibration plate, the end of the outlet pipe away from the upper pressing roller structure is fixedly connected to and communicates with the conical cover.

Preferably, a central shaft rod is rotatably disposed in the central portion of the metal elastic vibration plate, spiral blades are fixed to the upper end of the central shaft rod, multiple vibration mechanisms are fixed in an annular array at the lower end of the central shaft rod, multiple spiral scraping plates matching the metal filter screen are fixed in an annular array on the upper portion of the outer surface of the central shaft rod.

Preferably, the vibration mechanism comprises a link rod fixed to the lower end of the central shaft rod, and a plastic striking ball is fixed to the end of the link rod away from the central shaft rod.

Preferably, the link rod has elasticity and its vertical cross-section is diamond-shaped.

Preferably, upper pressing plates are rotatably disposed at the upper ends of the vertical sections of the concave base, a threaded pull rod is rotationally connected to the lower rear portion of the concave base, a knob is threadedly connected to the upper portion of the threaded pull rod for installing the upper pressing plate above the concave base to fix the hollow shaft rod 1, multiple support steel balls for supporting the outer roller ring are rotatably disposed in the inner upper portions of the vertical sections of the concave base.

Compared with the prior art, the present invention has the following beneficial effects:
1. The present invention can adjust roller pressing thickness conveniently and steplessly according to different rolling force requirements and tab thickness demands by controlling the air pump to fill air or hydraulic oil into the gap between the hollow shaft rod 1 and the hollow shaft rod 2, thereby changing the relative position between the outer roller ring and the hollow shaft rod 1. Meanwhile, the setting of the support mechanism can further enhance the support rigidity of the outer roller ring, ensuring that the pressure of the outer roller ring on the outer surface is uniform and stable under different thickness requirements, achieving precise control of tab thickness and meeting high-precision tab processing demands.
2. The present invention allows flexible switching between flexible roller pressing and rigid roller pressing. When smaller rolling force is required, air can be selected as the filling material, and the stiffness of the transition layer can be changed by adjusting air pressure to adjust the rolling bite angle. When larger rolling force is required, hydraulic oil can be selected as the filling material, thereby adapting to different rolling process requirements. Additionally, outer roller rings with different wall thicknesses can be selected according to actual needs, and the quantity and dimensions of support mechanisms can be adjusted according to the actual dimensions of electrode sheets in production, to achieve optimal control of tab roller pressing elongation rate, ensuring that tab performance meets different battery manufacturing standards and expanding the range of application scenarios.
3. The present invention provides a cleaning mechanism for treating air or hydraulic oil discharged from the liquid storage shells. Through the coordinated action of components such as the metal filter screen, spiral scraping plates, and vibration mechanisms, it can effectively remove metal sludge and air bubbles from the hydraulic oil, enabling the hydraulic oil to be recycled, reducing resource waste while lowering equipment maintenance costs. Furthermore, the threaded connection design between the conical cover, arc-shaped bottom shell, and metal filter screen makes these components easy to disassemble and assemble, facilitating replacement of the metal filter screen and cleaning of scraped sludge, thereby ensuring equipment cleanliness and good operating condition.
4. When the outer roller ring and the hollow shaft rod 1 are not coaxial, the outer roller ring always rotates eccentrically relative to the hollow shaft rod 1. The diameter of the outer roller ring is greater than the diameter of the limiting holes, and the diameter of the limiting holes is greater than the diameter of the hollow shaft rod 1. This design enables the outer roller ring to have a certain amount of eccentricity during rotation, which can increase the contact area with tabs and improve the uniformity of roller pressing effects. Meanwhile, the outer roller ring is connected to the hollow shaft rod 1 through support mechanisms. The setting of support mechanisms not only provides support force but also buffers impact forces on the outer roller ring to a certain extent, improving the structural stability of the entire apparatus.
5. The filtration and defoaming treatment of hydraulic oil in the present invention can ensure the purity of hydraulic oil, reduce wear on the hydraulic system caused by impurities and air bubbles, and further improve equipment durability.

### BRIEF DESCRIPTION OF THE DRAWINGS

FIG. 1 is a schematic diagram of the overall structure of the present invention;

FIG. 2 is an enlarged schematic diagram of part A in FIG. 1 of the present invention;

FIG. 3 is a schematic diagram of the overall structure from another perspective of the present invention;

FIG. 4 is a partial schematic diagram of the overall structure of the present invention;

FIG. 5 is an enlarged schematic diagram of part A in FIG. 4 of the present invention;

FIG. 6 is a schematic diagram of the internal structure of the upper pressing roller structure of the present invention;

FIG. 7 is an enlarged schematic diagram of part B in FIG. 6 of the present invention;

FIG. 8 is a schematic diagram of the left side of the internal structure of the upper pressing roller structure of the present invention;

FIG. 9 is a schematic diagram of the right side of the internal structure of the upper pressing roller structure of the present invention;

FIG. 10 is an enlarged schematic diagram of part D in FIG. 9 of the present invention;

FIG. 11 is a schematic diagram of the internal structure of the cleaning mechanism of the present invention;

FIG. 12 is an enlarged schematic diagram of part F in FIG. 11 of the present invention;

FIG. 13 is an enlarged schematic diagram of part E in FIG. 11 of the present invention.

In the FIGs.: 1. support frame; 2. inclined platform; 3. concave base; 31. upper pressing plate; 32. threaded pull rod; 33. knob; 34. support steel ball; 4. lower pressing roller; 5. upper pressing roller structure; 51. outer roller ring; 52. hollow shaft rod 1; 53. support mechanism; 531. liquid storage shell; 532. connecting rod; 533. arc-shaped steel plate; 534. piston; 535. drain pipe; 536. inlet pipe; 537. spring 1; 54. hollow shaft rod 2; 55. pointed cone; 56. sealing ring; 57. outlet hole; 58. limiting hole; 6. outlet pipe; 7. three-way pipe; 8. motor; 9. cleaning mechanism; 91. conical cover; 92. metal filter screen; 93. arc-shaped bottom shell; 94. metal elastic vibration plate; 95. central shaft rod; 96. spiral scraping plate; 98. vibration mechanism; 981. link rod; 982. plastic striking ball; 984. spiral blade; 99. V-shaped block; 90. spring 2; 10. air pump; 11. high-pressure oil pump; 12. electronic valve 1; 13. electronic valve 2; 14. electronic valve 3; 15. gear assembly.

### MODE FOR CARRYING OUT THE INVENTION

To make the technical means, creative features, objectives, and effects achieved by the present invention easy to understand, the present invention is further elaborated below in combination with specific embodiments.

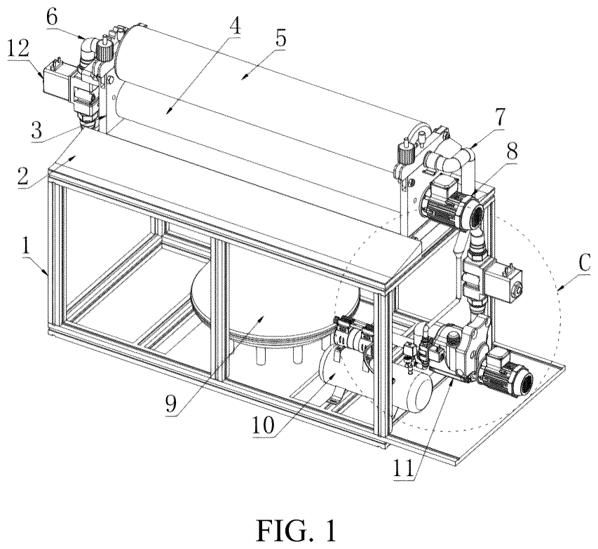

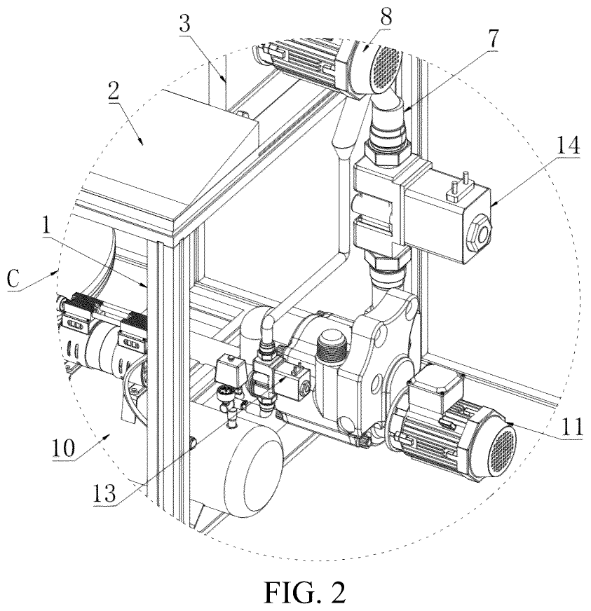

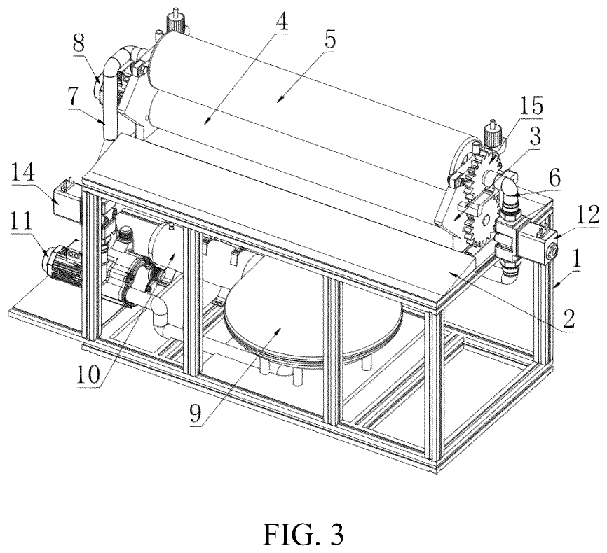

Embodiment 1, as shown in FIGS. 1, 2, 3, and 4, a roller pressing apparatus for tab processing comprises a support frame 1, an air pump 10, and a high-pressure oil pump 11. The air pump 10 and high-pressure oil pump 11 are both installed on the inner right side of the support frame 1.

Inclined platforms 2 are fixedly mounted on both front and rear sides of the upper end of the support frame 1. A concave base 3 is fixedly mounted in the upper central portion of the support frame 1. A gear assembly 15 is provided in the central portion of the left end of the concave base 3. A lower pressing roller 4 and an upper pressing roller structure 5 are rotationally connected from bottom to top in the inner central portion of the concave base 3. An outlet pipe 6 is installed in the upper portion of the left end of the vertical section of the concave base 3. An electronic valve 1 (12) is provided in the upper portion of the outlet pipe 6. A motor 8 and a three-way pipe 7 are sequentially provided from bottom to top at the right end of the vertical section of the concave base 3. The motor 8 is used to drive the rotation of the lower pressing roller 4. The gear assembly 15 is used for linking the lower pressing roller 4 and the upper pressing roller structure 5. A cleaning mechanism 9 is fixedly mounted in the inner central portion of the support frame 1. Two input ends of the three-way pipe 7 are respectively equipped with an electronic valve 2 (13) and an electronic valve 3 (14). The electronic valve 2 (13) and electronic valve 3 (14) are respectively installed at the output ends of the air pump 10 and high-pressure oil pump 11. The input end of the high-pressure oil pump 11 is connected to the bottom of the cleaning mechanism 9 through a pipeline.

The above-mentioned gear assembly 15 consists of two spur gears that mesh with each other. The two spur gears are respectively fixed to the right side of the hollow shaft rod 1 (52) and the right side of the lower pressing roller 4.

In the above arrangement, tabs are placed between the lower pressing roller 4 and the upper pressing roller structure 5 from the front or rear side. The motor 8 is started, and through the gear assembly 15, the lower pressing roller 4 and the upper pressing roller structure 5 are linked to rotate simultaneously in opposite directions, dragging the tabs between the lower pressing roller 4 and the upper pressing roller structure 5 to perform roller pressing operations and change the thickness of the tabs.

Furthermore, in actual production, the present case can select appropriate materials to fill inside the upper pressing roller structure 5 according to different rolling force requirements. For example, when smaller rolling force is required, air can be selected as the filling material, and the stiffness of the transition layer can be changed by adjusting the air pressure to achieve adjustment of the rolling bite angle. When larger rolling force is required, hydraulic oil can be selected as the filling material.

Additionally, the present case can also select outer roller rings 51 with different wall thicknesses according to rolling process requirements to achieve optimal control of tab roller pressing elongation rate.

To achieve the above objectives, the present case also provides an air pump 10 and a high-pressure oil pump 11, which can respectively fill air or hydraulic oil inside the upper pressing roller structure 5, and complete the adjustment process under the coordinated cooperation of electronic valve 2 (13), electronic valve 3 (14), and electronic valve 1 (12).

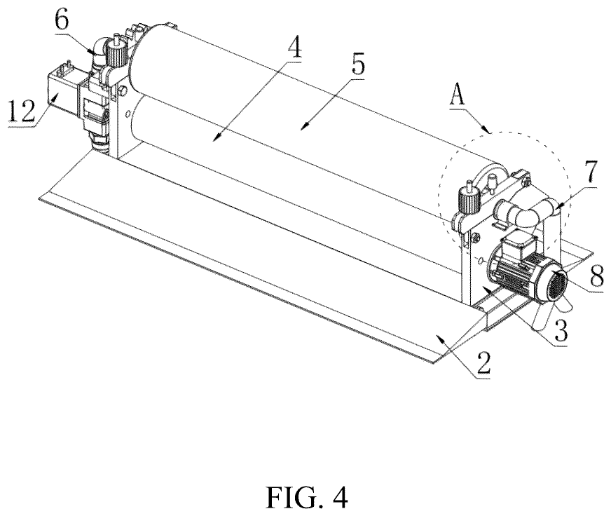

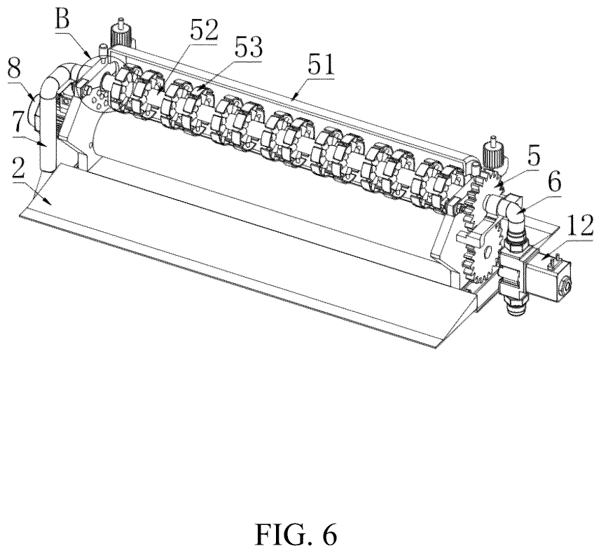

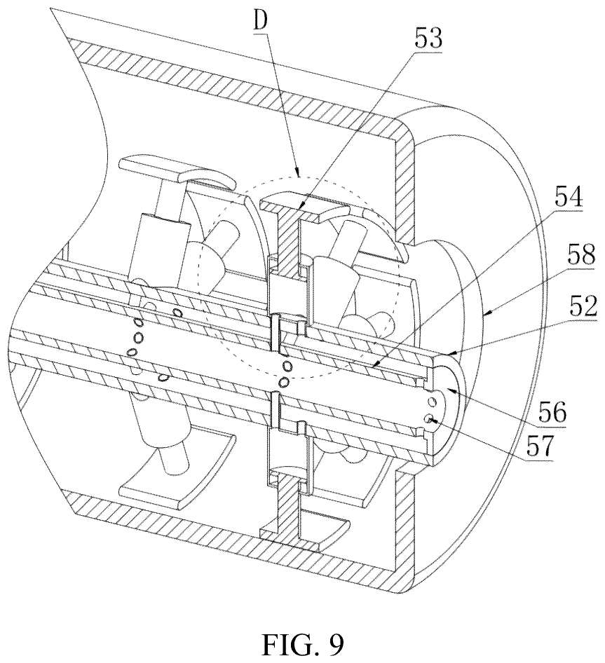

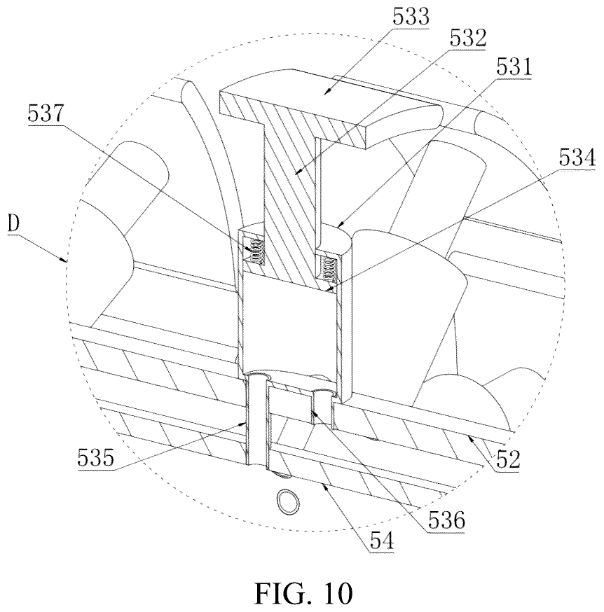

Specifically, to accomplish the above objectives, referring to FIGS. 4, 6, 8, 9, and 10, the upper pressing roller structure 5 comprises a hollow shaft rod 1 (52). The hollow shaft rod 1 (52) is rotationally connected to the inner upper portion of the vertical section of the concave base 3. Both left and right ends of the hollow shaft rod 1 (52) are rotationally connected to the outlet pipe 6 and three-way pipe 7 respectively. Multiple support mechanisms 53 are fixedly connected to the outer surface of the hollow shaft rod 1 (52). All the support mechanisms 53 are located within the inner cavity of the outer roller ring 51. An outer roller ring 51 is sleeved on the outer surface of the hollow shaft rod 1 (52). Limiting holes 58 are formed at both left and right ends of the outer roller ring 51. A hollow shaft rod 2 (54) is installed in the inner cavity of the hollow shaft rod 1 (52). A pointed cone 55 is fixed to the left end of the hollow shaft rod 2 (54). A sealing ring 56 is fixed to the right end of the hollow shaft rod 2 (54). The sealing ring 56 is used to seal the right side of the inner cavity of the hollow shaft rod 1 (52). Multiple outlet holes 57 are formed on the right side of the outer surface of the hollow shaft rod 2 (54) near the sealing ring 56.

In the above arrangement, the hollow shaft rod 1 (52) is used to transport hydraulic oil or air, and the hollow shaft rod 2 (54) is used to discharge hydraulic oil or air.

The above-mentioned pointed cone 55 can facilitate uniform diffusion of hydraulic oil or air in the gap between the hollow shaft rod 1 (52) and the hollow shaft rod 2 (54), enabling the oil pressure or air pressure inside multiple pointed cones 55 to communicate.

By starting the high-pressure oil pump 11 and electronic valve 3 (14) or the air pump 10 and electronic valve 2 (13) while closing electronic valve 1 (12), hydraulic oil or air can be respectively injected into the inner cavity of the hollow shaft rod 1 (52) through the three-way pipe 7 in a single operation. Thereafter, the hydraulic oil or air uniformly diffuses in the gap between the hollow shaft rod 1 (52) and the hollow shaft rod 2 (54), and respectively enters the inner cavities of multiple support mechanisms 53, driving the operation of multiple support mechanisms 53, adjusting the support range of the support mechanisms 53 for the outer roller ring 51. After adjusting to the appropriate roller pressing thickness, the air pump 10 and electronic valve 2 (13) or the high-pressure oil pump 11 and electronic valve 3 (14) are closed to maintain pressure, ensuring that the pressure in the inner cavities of the support mechanisms 53 remains unchanged.

When multiple support mechanisms 53 do not fully support the outer roller ring 51, during the subsequent tab roller pressing process, the outer roller ring 51 is not coaxial with the hollow shaft rod 1 (52), and the outer roller ring 51 always remains in an eccentric state relative to the hollow shaft rod 1 (52). When multiple support mechanisms 53 fully support the outer roller ring 51, during the subsequent tab roller pressing process, the outer roller ring 51 is coaxial with the hollow shaft rod 1 (52), and the outer roller ring 51 always remains in a non-eccentric state relative to the hollow shaft rod 1 (52).

After roller pressing is completed, electronic valve 1 (12) is opened, and under the elastic force of spring 1 (537), the air or hydraulic oil inside the support mechanisms 53 is discharged.

The diameter of the outer roller ring 51 is greater than the diameter of the limiting holes 58, and the diameter of the limiting holes 58 is greater than the diameter of the hollow shaft rod 1 (52), enabling the outer roller ring 51 to rotate eccentrically relative to the hollow shaft rod 2 (54).

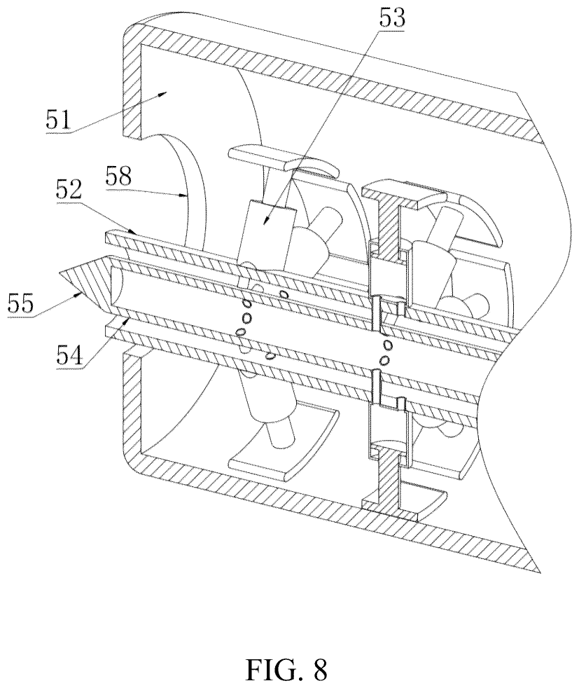

Specifically, to achieve the above capability of performing roller pressing operations on tab products of different thicknesses, referring to FIGS. 8, 9, and 10, in this embodiment, the support mechanism 53 comprises multiple liquid storage shells 531. Pistons 534 are slidably disposed in the inner cavities of all the liquid storage shells 531. A connecting rod 532 is fixedly mounted in the central portion of the end of the piston 534 away from the hollow shaft rod 1 (52). An arc-shaped steel plate 533 is fixed to the end of the connecting rod 532 away from the liquid storage shell 531. A drain pipe 535 and an inlet pipe 536 are fixed on the side of the inner cavity of the liquid storage shell 531 close to the hollow shaft rod 1 (52). The drain pipe 535 is used to connect the liquid storage shell 531 and the hollow shaft rod 2 (54). The inlet pipe 536 is used to connect the liquid storage shell 531 and the hollow shaft rod 1 (52). Multiple springs 1 (537) are jointly fixed between the end of the piston 534 away from the hollow shaft rod 1 (52) and the liquid storage shell 531.

Under the condition that electronic valve 1 (12) is open, air or hydraulic oil flows toward the gap between the hollow shaft rod 1 (52) and the hollow shaft rod 2 (54), expelling other substances in the gap between the hollow shaft rod 1 (52) and the hollow shaft rod 2 (54). After complete expulsion, electronic valve 1 (12) is closed. At this time, air or hydraulic oil continues to be injected into the gap and enters the inner cavities of the liquid storage shells 531 on the same side through multiple inlet pipes 536, pushing the pistons 534 outward. At this time, springs 1 (537) are in a compressed state. After reaching the required roller pressing thickness, the air pump 10 and electronic valve 2 (13) or the high-pressure oil pump 11 and electronic valve 3 (14) are closed to maintain pressure, ensuring that the pressure in the inner cavities of the support mechanisms 53 remains unchanged.

After roller pressing is completed, electronic valve 1 (12) is opened again. At this time, the air or hydraulic oil stored in the inner cavities of the liquid storage shells 531 is discharged through the drain pipes 535 on the same side to the inner cavity of the hollow shaft rod 2 (54) under the pushing action of spring 1 (537), and flows through multiple outlet holes 57 into the inner cavity of the outlet pipe 6, finally flowing into the cleaning mechanism 9 for treatment and storage, until all air or hydraulic oil flows out, and finally the support mechanisms 53 return to their initial state.

Multiple support mechanisms 53 in the same vertical plane are defined as one group, and adjacent groups of support mechanisms 53 have different installation angles.

Since multiple arc-shaped steel plates 533 located in the same vertical plane need to move inward or outward under the above adjustment, there are gaps between multiple arc-shaped steel plates 533 located in the same vertical plane. Thus, during the roller pressing process, when two adjacent arc-shaped steel plates 533 located in the same vertical plane simultaneously contact the outer roller ring 51, the roller pressing thickness will increase compared to the preset thickness, which does not conform to the preset roller pressing thickness. Therefore, in the implementation of the present case, different installation angles need to be used, so that the arc-shaped steel plates 533 in adjacent vertical planes can compensate for this defect. That is to say, two arc-shaped steel plates 533 in the same vertical plane will not simultaneously contact the outer roller ring 51, thus ensuring that the roller pressing thickness is always consistent and guaranteeing roller pressing quality.

Additionally, multiple drain pipes 535 can not only transport air or hydraulic oil but also serve as support components between the hollow shaft rod 1 (52) and the hollow shaft rod 2 (54), ensuring that while rotating synchronously, the gap between the hollow shaft rod 1 (52) and the hollow shaft rod 2 (54) remains uniform, thereby ensuring the uniformity and smoothness of air or hydraulic oil flow.

Embodiment 2: This embodiment can treat air or hydraulic oil flowing out from the inner cavities of the liquid storage shells 531 based on Embodiment 1, expelling air bubbles mixed inside the hydraulic oil.

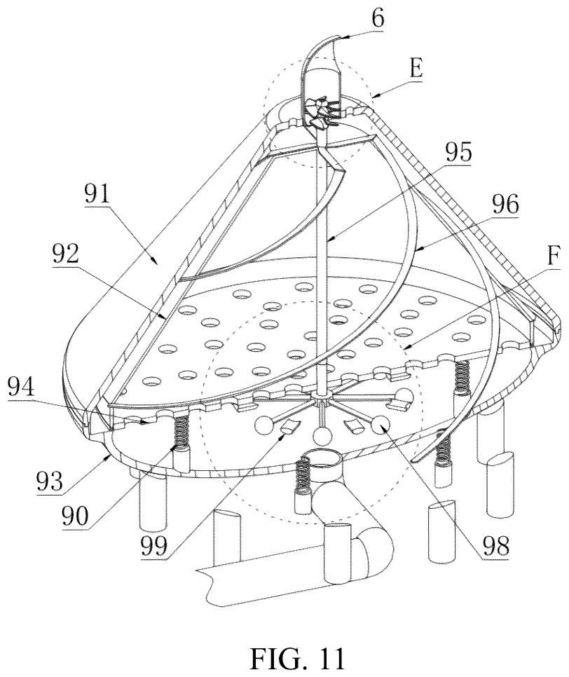

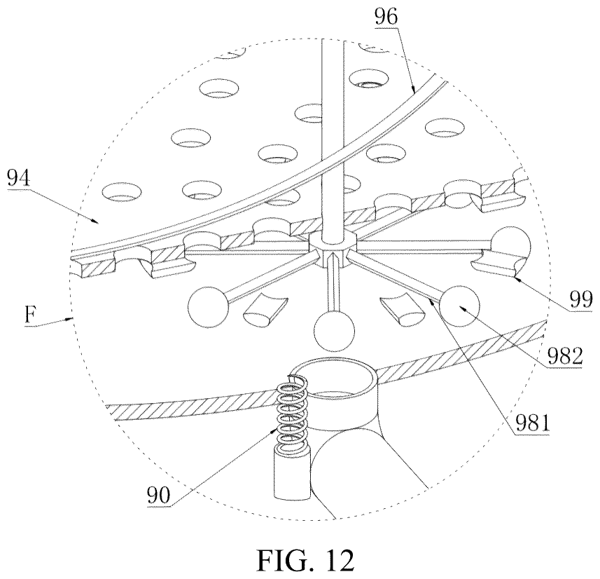

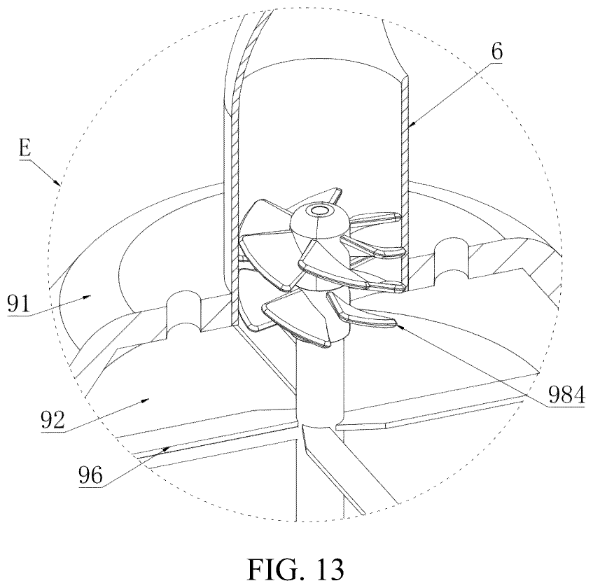

Specifically, to achieve the above objective, referring to FIGS. 11, 12, and 13, in the present case, the cleaning mechanism 9 comprises a conical cover 91. An arc-shaped bottom shell 93 is threadedly installed at the bottom of the conical cover 91. The arc-shaped bottom shell 93 is installed in the inner central portion of the support frame 1. The end of the pipeline away from the high-pressure oil pump 11 is fixedly connected to and communicates with the bottom of the arc-shaped bottom shell 93. A metal filter screen 92 is threadedly installed on the inner upper end of the arc-shaped bottom shell 93. A metal elastic vibration plate 94 is fixed to the bottom wall of the inner cavity of the metal filter screen 92. Multiple springs 2 (90) are fixed in an annular array on the outer side of the lower end of the metal elastic vibration plate 94. Magnet columns are fixed to the bottom of all the springs 2 (90). Multiple V-shaped blocks 99 are fixed in an annular array on the inner side of the lower end of the metal elastic vibration plate 94. The end of the outlet pipe 6 away from the upper pressing roller structure 5 is fixedly connected to and communicates with the conical cover 91.

The above-mentioned metal elastic vibration plate 94 has multiple oil passage holes formed thereon for allowing hydraulic oil from the upper part of the metal elastic vibration plate 94 to flow to the lower part of the metal elastic vibration plate 94.

As shown in FIG. 11, an exhaust hole is formed at the upper end of the conical cover 91.

During implementation, hydraulic oil or air discharged from the inner cavity of the upper pressing roller structure 5 flows through the outlet pipe 6 to the inner cavity of the conical cover 91. Air discharged into the inner cavity of the conical cover 91 can be expelled to the outside through the exhaust hole, while hydraulic oil remains in the inner cavity of the conical cover 91.

When hydraulic oil enters the inner cavity of the conical cover 91, it flows to the outer surface of the metal filter screen 92, undergoes filtration through the outer surface of the metal filter screen 92, and then the filtered hydraulic oil enters the inner cavity of the metal filter screen 92 through the outer surface of the metal filter screen 92, passing through the metal elastic vibration plate 94 and finally moving to the inner cavity of the arc-shaped bottom shell 93 for storage.

Furthermore, to perform defoaming treatment on hydraulic oil flowing into the inner cavity of the arc-shaped bottom shell 93, referring to FIGS. 11, 12, and 13, in the present case, a central shaft rod 95 is rotatably disposed in the central portion of the metal elastic vibration plate 94. Spiral blades 984 are fixed to the upper end of the central shaft rod 95. Multiple vibration mechanisms 98 are fixed in an annular array at the lower end of the central shaft rod 95. Multiple spiral scraping plates 96 matching the metal filter screen 92 are fixed in an annular array on the upper portion of the outer surface of the central shaft rod 95.

The vibration mechanism 98 comprises a link rod 981 fixed to the lower end of the central shaft rod 95. A plastic striking ball 982 is fixed to the end of the link rod 981 away from the central shaft rod 95.

The link rod 981 has elasticity and its vertical cross-section is diamond-shaped.

In this embodiment, the density of the plastic striking ball 982 is less than the density of the oil liquid, so after the plastic striking ball 982 descends under the action of the V-shaped blocks 99, it can quickly bounce upward to strike the metal elastic vibration plate 94.

Additionally, the diamond shape of the link rod 981 can also quickly cut through the oil liquid and, under the action of its own elastic force, assist the plastic striking ball 982 to rise rapidly.

In the above arrangement, during the process of hydraulic oil or air flowing through the outlet pipe 6 to the outer surface of the metal filter screen 92 for filtration, the air or hydraulic oil drives the spiral blades 984 and central shaft rod 95 to rotate and operate. Through the spiral scraping plates 96, partial metal sludge adhering to the outer surface of the metal filter screen 92 is scraped off. Through the arc-shaped form of the spiral scraping plates 96, metal sludge can be continuously scraped downward and finally stored in the gap between the metal filter screen 92 and the arc-shaped bottom shell 93.

Additionally, during this process, the central shaft rod 95 can drive the link rod 981 and plastic striking ball 982 to rotate simultaneously. When the plastic striking ball 982 encounters a V-shaped block 99, the V-shaped block 99 will push the plastic striking ball 982 downward, causing the link rod 981 to generate elastic force. After the plastic striking ball 982 leaves the V-shaped block 99, the plastic striking ball 982 will quickly bounce upward, striking the metal elastic vibration plate 94 to generate vibration. Through the metal elastic vibration plate 94, the vibration is uniformly transmitted to the oil liquid, accelerating the expulsion of bubbles in the lower oil liquid.

Additionally, the spring 2 (90) provided in the present case can not only support the metal elastic vibration plate 94 without affecting vibration transmission but also, through the magnet columns at the bottom of the spring 2 (90), can adsorb partial metal sludge to ensure oil purity. The quantity and installation positions of the spring 2 (90) can be adjusted according to requirements in specific implementation processes.

Furthermore, this embodiment employs threaded designs between the conical cover 91 and arc-shaped bottom shell 93, as well as between the conical cover 91 and metal filter screen 92, facilitating separation of the conical cover 91 from the arc-shaped bottom shell 93 and the conical cover 91 from the metal filter screen 92, thereby facilitating replacement of the metal filter screen 92 and convenient cleaning of sludge scraped by the spiral scraping plates 96 between the metal filter screen 92 and conical cover 91.

The hydraulic oil with bubbles eliminated can be drawn out again for use by the high-pressure oil pump 11 with the cooperation of the pipeline.

Embodiment 3: This embodiment designs the top of the concave base 3 based on Embodiment 2, facilitating installation, removal, inspection, maintenance, and replacement of the upper pressing roller structure 5.

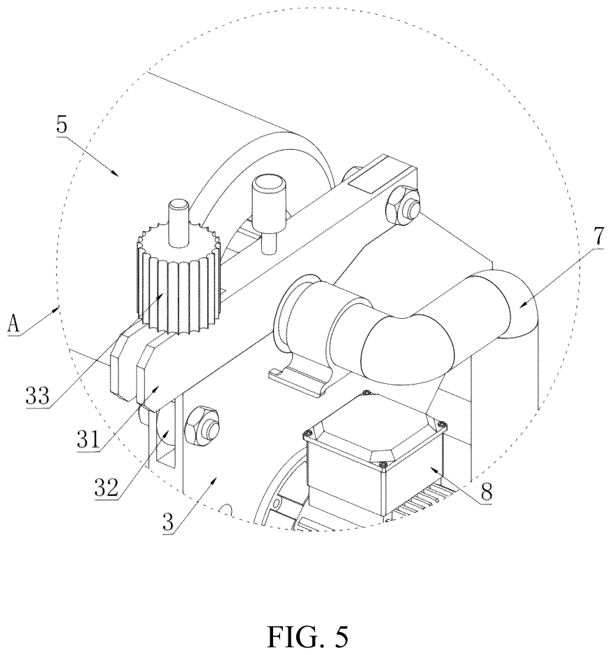

Specifically, to achieve the above objective, referring to FIG. 5, in this embodiment, upper pressing plates 31 are rotatably disposed at the upper ends of the vertical sections of the concave base 3. A threaded pull rod 32 is rotationally connected to the lower rear portion of the concave base 3. A knob 33 is threadedly connected to the upper portion of the threaded pull rod 32 for installing the upper pressing plate 31 above the concave base 3 to fix the hollow shaft rod 1 (52). Multiple support steel balls 34 for supporting the outer roller ring 51 are rotatably disposed in the inner upper portions of the vertical sections of the concave base 3.

In the present case, the knob 33 and threaded pull rod 32 are threadedly connected, the upper pressing plate 31 and concave base 3 are rotationally connected, and the threaded pull rod 32 and concave base 3 are rotationally connected. Therefore, after rotating the knob 33, the upper pressing plate 31 can be pressed down to fix the upper pressing roller structure 5. Conversely, rotating the knob 33 in the reverse direction can release the limitation on the upper pressing plate 31, thereby facilitating removal of the upper pressing roller structure 5.

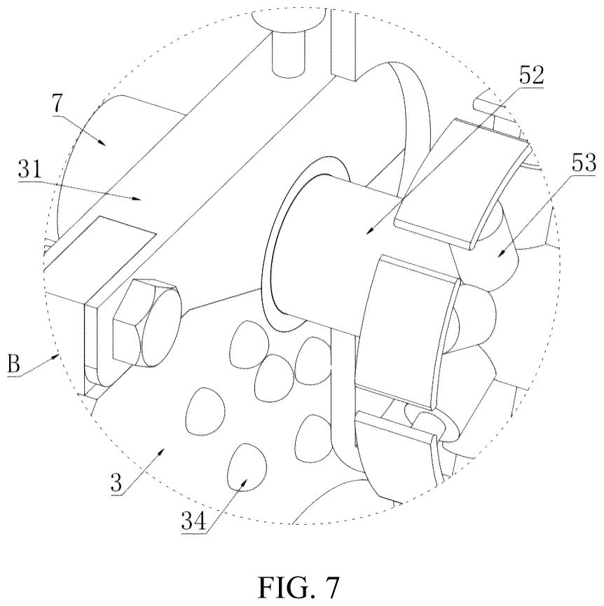

Additionally, referring to FIG. 7, through the multiple support steel balls 34 provided in the present case, the outer roller ring 51 can be supported without affecting its rotation, ensuring that the outer roller ring 51 always remains centered relative to the lower pressing roller 4, thereby guaranteeing the quality of tab roller pressing.

The above shows and describes the basic principles, main features, and advantages of the present invention. Those skilled in the art should understand that the present invention is not limited to the above embodiments. The embodiments and descriptions in the specification are only to illustrate the principles of the present invention. Without departing from the spirit and scope of the present invention, the present invention will have various changes and improvements, all of which fall within the scope of protection claimed by the present invention. The scope of protection of the present invention is defined by the attached claims and their equivalents.

1. A roller pressing apparatus for tab processing, comprising a support frame (1), an air pump (10), and a high-pressure oil pump (11), characterized in that: the air pump (10) and high-pressure oil pump (11) are both installed on the inner right side of the support frame (1);
Inclined platforms (2) are fixedly mounted on both front and rear sides of the upper end of the support frame (1), a concave base (3) is fixedly mounted in the upper central portion of the support frame (1), a gear assembly (15) is provided in the central portion of the left end of the concave base (3), a lower pressing roller (4) and an upper pressing roller structure (5) are rotationally connected from bottom to top in the inner central portion of the concave base (3), an outlet pipe (6) is installed in the upper portion of the left end of the vertical section of the concave base (3), an electronic valve 1 (12) is provided in the upper portion of the outlet pipe (6), a motor (8) and a three-way pipe (7) are sequentially provided from bottom to top at the right end of the vertical section of the concave base (3), the motor (8) is used to drive the rotation of the lower pressing roller (4), the gear assembly (15) is used for linking the lower pressing roller (4) and the upper pressing roller structure (5), a cleaning mechanism (9) is fixedly mounted in the inner central portion of the support frame (1), two input ends of the three-way pipe (7) are respectively equipped with an electronic valve 2 (13) and an electronic valve 3 (14), and the electronic valve 2 (13) and electronic valve 3 (14) are respectively installed at the output ends of the air pump (10) and high-pressure oil pump (11), the input end of the high-pressure oil pump (11) is connected to the bottom of the cleaning mechanism (9) through a pipeline.

2. The roller pressing apparatus for tab processing according to claim 1, characterized in that: the upper pressing roller structure (5) comprises a hollow shaft rod 1 (52), the hollow shaft rod 1 (52) is rotationally connected to the inner upper portion of the vertical section of the concave base (3), both left and right ends of the hollow shaft rod 1 (52) are rotationally connected to the outlet pipe (6) and three-way pipe (7) respectively, multiple support mechanisms (53) are fixedly connected to the outer surface of the hollow shaft rod 1 (52), all the support mechanisms (53) are located within the inner cavity of the outer roller ring (51), an outer roller ring (51) is sleeved on the outer surface of the hollow shaft rod 1 (52), limiting holes (58) are formed at both left and right ends of the outer roller ring (51), a hollow shaft rod 2 (54) is installed in the inner cavity of the hollow shaft rod 1 (52), a pointed cone (55) is fixed to the left end of the hollow shaft rod 2 (54), a sealing ring (56) is fixed to the right end of the hollow shaft rod 2 (54), the sealing ring (56) is used to seal the right side of the inner cavity of the hollow shaft rod 1 (52), multiple outlet holes (57) are formed on the right side of the outer surface of the hollow shaft rod 2 (54) near the sealing ring (56).

3. The roller pressing apparatus for tab processing according to claim 2, characterized in that: the diameter of the outer roller ring (51) is greater than the diameter of the limiting holes (58), the diameter of the limiting holes (58) is greater than the diameter of the hollow shaft rod 1 (52), enabling the outer roller ring (51) to rotate eccentrically relative to the hollow shaft rod 2 (54).

4. The roller pressing apparatus for tab processing according to claim 2, characterized in that: the support mechanism (53) comprises multiple liquid storage shells (531), pistons (534) are slidably disposed in the inner cavities of all the liquid storage shells (531), a connecting rod (532) is fixedly mounted in the central portion of the end of the piston (534) away from the hollow shaft rod 1 (52), an arc-shaped steel plate (533) is fixed to the end of the connecting rod (532) away from the liquid storage shell (531), a drain pipe (535) and an inlet pipe (536) are fixed on the side of the inner cavity of the liquid storage shell (531) close to the hollow shaft rod 1 (52), the drain pipe (535) is used to connect the liquid storage shell (531) and the hollow shaft rod 2 (54), the inlet pipe (536) is used to connect the liquid storage shell (531) and the hollow shaft rod 1 (52), multiple springs 1 (537) are jointly fixed between the end of the piston (534) away from the hollow shaft rod 1 (52) and the liquid storage shell (531).

5. The roller pressing apparatus for tab processing according to claim 1, characterized in that: multiple support mechanisms (53) in the same vertical plane are defined as one group, and adjacent groups of support mechanisms (53) have different installation angles.

6. The roller pressing apparatus for tab processing according to claim 1, characterized in that: the cleaning mechanism (9) comprises a conical cover (91), an arc-shaped bottom shell (93) is threadedly installed at the bottom of the conical cover (91), the arc-shaped bottom shell (93) is installed in the inner central portion of the support frame (1), the end of the pipeline away from the high-pressure oil pump (11) is fixedly connected to and communicates with the bottom of the arc-shaped bottom shell (93), a metal filter screen (92) is threadedly installed on the inner upper end of the arc-shaped bottom shell (93), a metal elastic vibration plate (94) is fixed to the bottom wall of the inner cavity of the metal filter screen (92), multiple springs 2 (90) are fixed in an annular array on the outer side of the lower end of the metal elastic vibration plate (94), magnet columns are fixed to the bottom of all the springs 2 (90), multiple V-shaped blocks (99) are fixed in an annular array on the inner side of the lower end of the metal elastic vibration plate (94) the end of the outlet pipe (6) away from the upper pressing roller structure (5) is fixedly connected to and communicates with the conical cover (91).

7. The roller pressing apparatus for tab processing according to claim 6, characterized in that: a central shaft rod (95) is rotatably disposed in the central portion of the metal elastic vibration plate (94), spiral blades (984) are fixed to the upper end of the central shaft rod (95), multiple vibration mechanisms (98) are fixed in an annular array at the lower end of the central shaft rod (95), multiple spiral scraping plates (96) matching the metal filter screen (92) are fixed in an annular array on the upper portion of the outer surface of the central shaft rod (95).

8. The roller pressing apparatus for tab processing according to claim 7, characterized in that: the vibration mechanism (98) comprises a link rod (981) fixed to the lower end of the central shaft rod (95), and a plastic striking ball (982) is fixed to the end of the link rod (981) away from the central shaft rod (95).

9. The roller pressing apparatus for tab processing according to claim 8, characterized in that: the link rod (981) has elasticity and its vertical cross-section is diamond-shaped.

10. The roller pressing apparatus for tab processing according to claim 8, characterized in that: upper pressing plates (31) are rotatably disposed at the upper ends of the vertical sections of the concave base (3), a threaded pull rod (32) is rotationally connected to the lower rear portion of the concave base (3), a knob (33) is threadedly connected to the upper portion of the threaded pull rod (32) for installing the upper pressing plate (31) above the concave base (3) to fix the hollow shaft rod 1 (52), multiple support steel balls (34) for supporting the outer roller ring (51) are rotatably disposed in the inner upper portions of the vertical sections of the concave base (3).
